(19) United States
(12) Patent Application Publication
(10) Pub. No.: US 2017/0363431 A1
(43) Pub. Date: Dec. 21, 2017

(54) LOCATION METHOD AND CORRESPONDING TERMINALS, VEHICLE, COMPUTER PROGRAM PRODUCT AND STORAGE MEDIUM

(71) Applicant: THOMSON LICENSING, Issy les Moulineaux (FR)

(72) Inventors: Jean-Claude COLMAGRO, MOUAZE (FR); Kevin PLATEL, Pléssé (FR); Xavier LAMI, Rennes (FR); Fabien BATTINI, Thorigné-Fouillard (FR); Florian MOREL, Chateaubourg (FR)

(21) Appl. No.: 15/535,056

(22) PCT Filed: Dec. 1, 2015
(86) PCT No.: PCT/EP2015/078230

§ 371 Date: Jun. 11, 2017

(30) Foreign Application Priority Data
Dec. 11, 2014 (FR) 1462288

(51) Int. Cl. G01C 21/34; G01C 21/10; G01C 21/36; H04W 4/02

(52) U.S. Cl. CPC G01C 21/3438; H04W 4/025; G01C 21/10; G01C 21/362

(57) ABSTRACT

The present disclosure relates to a method for locating a first mobile terminal, the method including obtaining of at least one route of the first mobile terminal, defined by at least: a departure point, representative of a geographical location of the first mobile terminal; an arrival point, representative of a determined geographical location. According to at least one embodiment, the obtaining includes at least: an establishment of a communication between the first terminal and a second terminal, at an instant which is a function of a determined timestamp; a provision of the geographical location of the first terminal and/or a geographical location of the second terminal during the communication. The present disclosure also relates to the corresponding terminals, vehicles, computer program product and storage media.

### 1. FIELD OF THE INVENTION

The field of the invention relates to the assistance of users in locating a communication terminal.

An assistance method, a computer program product, a storage medium, electronic terminals and a corresponding vehicle are described.

Many solutions of the prior art enable a user of a communication terminal to obtain, using his terminal, the location of a target to be reached and/or the directions on a journey to be made in order to reach such a target. The target is often designated by a postal address (975, avenue des Champs Blancs 35510 Cesson-Sévigné), and therefore fixed. Some solutions also enable a user to reach a mobile target. Thus the solution described by patent application US 2014/0114564 enables a user to obtain, from a location server, the location of the target which he wishes to reach, even if this is mobile. However, this solution only enables the user to receive, when he communicates with the server, the last known position of the target, for this server, which may prove insufficient to effectively guide the user, especially when the terminal only communicates intermittently with the server.

### 2. SUMMARY OF THE INVENTION

The invention makes it possible to improve the situation by proposing a method making it possible, in at least one embodiment, to locate a terminal more appropriately than some solutions of the prior art.

In particular, an aspect of the present disclosure relates to a method for locating at least a first mobile terminal, said method comprising:
at least one obtaining of at least one route of said first mobile terminal, defined by at least:
   a departure point, representative of a geographical location of said first mobile terminal;
   an arrival point, representative of a determined geographical location.

According to at least one particular embodiment of the method, said obtaining comprises at least:
an establishment of a communication between the first terminal and a second terminal, at an instant which is a function of a determined timestamp;
a provision of said geographical location of said first terminal and/or a geographical location of said second terminal during said communication.

According to the embodiments, the location method may be implemented either on the first terminal, or on the second terminal.

According to at least one particular characteristic, said arrival point takes account of said geographical location of said second terminal.

According to at least one particular embodiment, the location method comprises a first and at least a second obtaining and, during the communication established at the time of said first obtaining, said first obtaining comprises a determination of at least one obtaining parameter relating to said second obtaining, one at least of said at least one determined obtaining parameters being the timestamp of the establishment of the communication of said second obtaining.

According to at least one particular characteristic, said obtaining comprises, prior to said provision of said geographical location of said first and/or second terminal, an acquisition of said geographical location to be provided.

According to at least one particular characteristic, said communication is a wireless communication.

According to at least one particular embodiment, said at least one obtaining parameters relating to said second obtaining belong to the group comprising:
the timestamp of the establishment of the communication of said second obtaining;
a type of wireless communication interface to be used for the establishment of the communication of said second obtaining;
a desired degree of precision of said geographical location provided at the time of said second obtaining;
a minimum duration of activation of a wireless communication interface during said second obtaining;
a maximum duration of activation of a wireless communication interface during said second obtaining;
an estimated time of autonomy of at least one battery of said first and/or second terminal;
a level of charge of at least one battery of said first and/or second terminal;
a current average speed of said first and/or second terminal;
a type of environment of said first and/or second terminal.

According to at least on particular characteristic, said obtaining further comprises a selection of at least one type of wireless communication to be implemented by said communication.

According to at least on particular characteristic, said obtaining further comprises a deactivation of at least one wireless communication interface implemented at the time of said communication.

According to at least one particular characteristic, said obtaining of said route comprises a calculation and/or a reception of said departure and/or arrival point defining said route, by at least one of said first and/or second terminals.

According to at least one particular characteristic, said method comprises a restitution, by at least one of said terminals, of said at least one route.

Although not explicitly described, the embodiments presented can be implemented using any combination or sub-combination. For example, an embodiment in which the arrival point takes account of said geographical location of said second terminal can be combined with an embodiment in which said obtaining further comprises a deactivation of at least one wireless communication interface implemented at the time of said communication.

Other embodiments, easily conceivable by those skilled in the art on reading the present description, are also included within the scope of the invention.

In particular, the present disclosure is not limited to an obtaining of a single route.

According to another aspect, the present disclosure relates to a mobile communication terminal comprising geographical location means, said mobile terminal comprising a processor configured for:
at least one obtaining of at least one route of said mobile terminal, defined by at least:
   a departure point, representative of a geographical location of said mobile terminal;
   an arrival point, representative of a determined geographical location.

According to at least one particular embodiment, said processor is further configured so that said obtaining comprises at least:
an establishment of a communication between said mobile terminal and another terminal, at an instant which is a function of a determined timestamp;
a provision of said geographical location of said mobile terminal and/or a geographical location of said other terminal during said communication.

Although not explicitly described, said mobile terminal can be configured to implement the location method of the present disclosure in any one of its embodiments.

According to another aspect, the present disclosure relates to a communication terminal comprising a processor configured for:
at least one obtaining of at least one route of another terminal, said other terminal being mobile, said route being defined by at least:
   a departure point, representative of a geographical location of said other terminal;
   an arrival point, representative of a determined geographical location.

According to at least one particular embodiment, said processor is further configured so that said obtaining comprises at least:
an establishment of a communication between the terminal and said other terminal, at an instant which is a function of a determined timestamp;
a provision of said geographical location of said other terminal and/or a geographical location of said terminal during said communication.

Although not explicitly described, said terminal can be configured to implement the location method of the present disclosure in any one of its embodiments.

According to another aspect, the present disclosure relates to a vehicle equipped with a communication terminal in any one of the embodiments of the present disclosure.

According to yet another aspect, the invention relates to a computer program product comprising program code instructions for executing the above location method, in any one of the aforementioned embodiments, when said program is executed by a computer.

According to yet another aspect, the invention relates to a computer-readable storage medium on which is saved a computer program comprising program code instructions for executing the method of the invention, in any one of the aforementioned embodiments, when said program is executed by a computer.

Such a computer-readable storage medium can take the form of a computer program product loaded onto at least one computer-readable storage medium comprising computer-readable and computer-executable program code instructions.

Thus, in the present patent application, a computer-readable storage medium is considered as being a non-transitory storage medium having the intrinsic capacity to store information and the intrinsic capacity to enable a restitution of the items of information which it stores.

A computer-readable storage medium can be for example, but not only, a system, a device or an item of equipment which is electronic, magnetic, optical, electromagnetic or infra-red, made of semiconductors or implements a combination of the techniques previously mentioned. It should be underlined that the following elements, which provide more specific examples of computer-readable storage media to which the principles of the invention can be applied, are essentially mentioned for illustrative purposes and in no case constitute an exhaustive list, as will be easily interpreted by those skilled in the art: a portable computer diskette, a hardware disc, a memory of ROM (Read Only Memory) type, an erasable memory of EPROM (Erasable Programmable Read Only Memory) type or flash memory, a portable compact disc comprising a ROM memory (CD ROM), an item of optical storage equipment, an item of magnetic storage equipment, or any suitable combination of the preceding elements.

As would be easily understandable for those skilled in the art, according to variants, the aspects of the present invention can be implemented by an item of equipment, by a method or a computer-readable storage medium. Thus, aspects of the present invention can be implemented in certain embodiments in the form of entirely hardware components (for example an electronic component or an electronic card equipped with components), or in the form of entirely software components (including for example firmware components, a “resident” software program, microcode, etc.). Other embodiments can implement both hardware components and software components. Moreover, these hardware or software components can be implemented in a same physical device or distributed in different physical devices.

In the present document, the term “module” will generally designate a component which can correspond either to a hardware component or to a software component. Moreover, aspects of the present invention can be implemented in the form of a computer-readable storage medium. Any combination of one or more computer-readable storage media can be used.

### 3. LIST OF FIGURES

The invention will be better understood, and other specific features and advantages will emerge upon reading the following detailed description, relating to a particular embodiment, the description making reference to the annexed drawings wherein:

FIG. 1A shows the general principle of the invention;

FIG. 1B shows a first route between a first mobile terminal and a second terminal, obtained according to a particular embodiment of the invention at an instant t0;

FIG. 1C shows a second route, between the two terminals of FIG. 1A, obtained at an instant t1 greater than instant t0 of FIG. 1A;

FIG. 1D shows a third route, between the two terminals of FIGS. 1A and 1B, obtained at an instant t2 greater than instant t1 of FIG. 1B;

FIG. 1E shows the different instants of obtaining the routes shown in FIGS. 1B to 1D;

FIG. 2 describes the location method of the invention, according to a particular embodiment, compatible with the embodiments described in relation to FIGS. 1A, 1B, 1C, 1D and 1E.

FIG. 3 shows a terminal according to a particular embodiment of the invention.

A same element is designated in all the figures by the same reference symbol.

The figures shown are for illustrative purposes only and in no case limit the invention to the embodiments shown.

### 4. DESCRIPTION OF EMBODIMENTS OF THE INVENTION

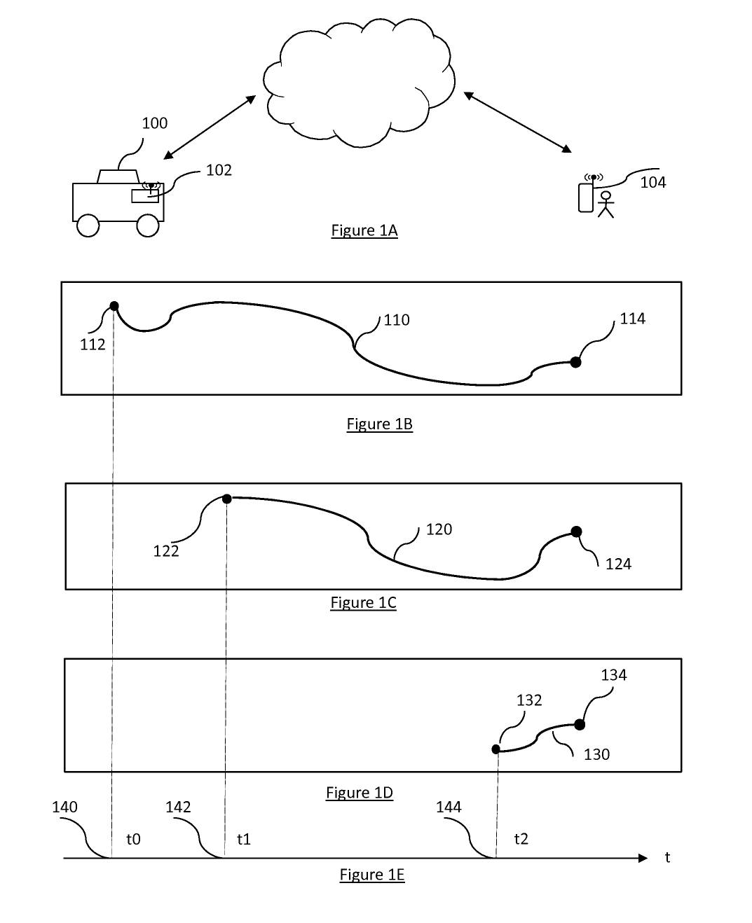

The general principle of the invention is presented in relation to FIG. 1A.

Some embodiments of the invention make it possible to offer an assistance to at least one user equipped with a communication terminal (102, 104), by a method for locating at least one mobile terminal. This may be a mobile terminal with which the user is equipped or a mobile terminal with which a third party is equipped, whose movement the user wishes to monitor. For this purpose, in some embodiments, as shown by FIGS. 1A to 1D, the location method comprises at least one obtaining of at least one route (110, 120, 130) of the mobile terminal, from a departure point (112, 122, 132) to a determined arrival point (114, 124, 134). In the embodiment of FIGS. 1A to 1D, the departure point 112 of a route corresponds to the current location of the mobile terminal 102.

In some embodiments, the arrival point 114 may be determined by taking account of the current position of another terminal (for example of the user's terminal if the user is monitoring the progress of another terminal or, if the user is monitoring the progress of his own terminal, of another terminal with which a third party whom the user wishes to reach is equipped).

In other embodiments, the arrival point may correspond to a fixed determined position (for example a shop, or a public or private place). It may for example be a location stored by the two terminals, for example a location of a particular place, such as the home or the place of work of a contact common to the two terminals, in an address book or in a social network for example, or a location of a public or private place known to a location service (a shopping centre, a service station, a restaurant, a school, etc.).

The arrival point (114, 124, 134) may correspond to a meeting point of the two terminals (such as an entrance of a shopping centre to which the user of one of the terminal has gone) or to a destination of the mobile terminal whose route is to be obtained (such as a place of residence of a contact common to the two terminals or a shop), independent of the position of the other terminal.

For example, in at least one particular embodiment, a parent may remotely monitor the movement of a child equipped with a mobile terminal going to a particular place (shop, swimming pool, etc.).

The obtaining of a route notably implements a communication between the two terminals (102, 104). This communication is established at an instant taking account of a determined timestamp, established for example with respect to a time reference system common to the two terminals, and known to the two terminals. It includes a provision of the current location of at least one of the terminals to the other of said terminals. This latter terminal can thus know in real time (or nearly in real time) the positioning of the other terminal.

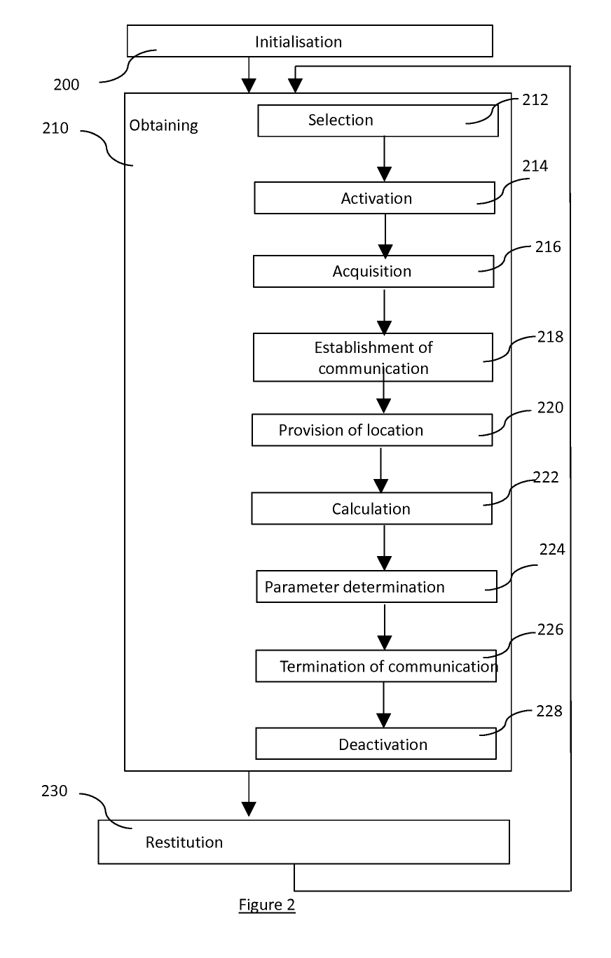

The location method of the invention, in one of its embodiments, is now presented in more detail in relation to FIGS. 1A to 1E and 2. As already discussed, the method can be implemented in the terminal whose route is obtained or in another terminal. For the purposes of simplification, in the remainder of the description, the term “local” terminal means the user's terminal, on which the method is implemented, and the term “remote” terminal means the terminal with which the “local” terminal communicates.

In the embodiment shown in FIG. 1A, the users of the two terminals (102, 104) can move towards one another, or one can go to meet the other, this latter itself being able to move from its initial position. In particular, the speeds of movement of the two terminals can be very different. Thus, as shown, one of the terminals 102 may for example equip a vehicle 100 (for example its dashboard) or be momentarily present in a vehicle (for example if it is the connected watch, a tablet or a smartphone of the driver or of one of the passengers) and travel a large distance, while the other terminal 104 may travel a small distance (for example if it is a portable terminal of a pedestrian user).

In the embodiment shown in FIG. 2, the method comprises an initialisation 200, at which time the two terminals notably determine a timestamp relating to a first obtaining 210 of a route (for example by SMS exchange and storage by each terminal of a timestamp encapsulated in the text of an SMS).

In the embodiment shown in FIGS. 1A to 1E and 2, the method then comprises a first obtaining of at least one route 110. In the particular embodiment shown in FIG. 1A, a single route is obtained, whose departure point is the current location of the mobile terminal 102, and the arrival point is the current geographical location of the terminal 104 to be reached.

In other embodiments, several routes may be obtained. It may for example involve routes possessing the same departure and arrival points (and differing for example in other information, such as a journey to be made between these departure and arrival points), or routes possessing a same departure point and differing notably by their arrival point (an arrival point corresponding for example to a possible meeting point of the two terminals (102, 104), and which may in particular correspond to the current geographical location of the terminal 104).

In the embodiment shown in FIG. 2, in which the method is implemented in a terminal equipped with wireless communication means, the obtaining 210 of at least one route comprises a selection 212 of at least one type of communication interface, for example a selection 212 of a type of wireless communication interface, from among different types of wireless communication interfaces present on the local terminal. For example, this may be an interface of GSM (Global System for Mobile Communications, defined by the European Telecommunication Standards Institute) type, or an interface of “3G” or “4G” (“third generation of mobile telecommunications technology” or “fourth generation of mobile telecommunications technology” defined by the International Telecommunication Union) type, or an interface adapted to wireless communication in a local network, for example an interface of “Wifi®” (as defined by standard IEE 802.11) type.

According to the embodiments, the two terminals can select the same type of wireless communication (chosen for example at the time of the initialisation) or different types of wireless communication (the establishment of a communication between the two terminals in this case implementing a gateway for example).

In at least one particular embodiment, the obtaining 210 comprises an activation 214 of a wireless communication interface of the local terminal. This step is optional. In fact, in some embodiments, the wireless communication interface can be activated at the time of starting up the local terminal for example, or at the time of initialisation 200, the wireless communication interface then remaining continuously activated.

In the embodiment of FIG. 2, the method further comprises an acquisition 216 of the geographical location of the local terminal, obtained for example by a module of GPS (Global Positioning System) type of the local terminal. This acquisition 216 is optional. In fact, in some embodiments, in particular when the local terminal is a non-mobile terminal, the geographical location of the local terminal may have been acquired beforehand and be stored by the local terminal In other embodiments, the local terminal can store a previous acquisition and not acquire a new location if, due to motion or speed sensors for example, it knows it remained immobile (or not very mobile) since the last acquisition.

In the embodiment shown, the obtaining 210 further comprises an establishment 218 of a communication between the local terminal and the remote terminal. This communication can notably implement the activated wireless communication means, and be carried out in data mode or by the encapsulation of data in voice or text.

Thus, in a particular embodiment, a terminal can communicate by using data encapsulated in voice, transported for example using GSM or 3G or 4G, and the other terminal can receive the data in the form of communication by means of an IP (Internet Protocol) protocol.

According to the embodiments, the establishment 218 of the communication can be carried out at an instant t0 corresponding to a determined timestamp or at an instant t0 close to the determined timestamp. Thus, in some embodiments implementing wireless communication modules, the activation 214 of the wireless communication interface can be implemented when the current timestamp is equal to the determined timestamp or slightly in advance, for example 5 minutes or 1 minute before the current timestamp has the value of the determined timestamp, a first attempt at establishing a communication being carried out when the current timestamp equals the determined timestamp.

According to the embodiments of the invention, one or more attempts at establishing a communication can be carried out before the establishment of communication of the two terminals. In fact, one of the terminals may have been turned off or put into standby mode or is momentarily in a geographical area making a communication difficult or impossible.

According to the embodiments, the communication interfaces implemented during several successive attempts can be identical or different.

In some embodiments, a new attempt can be made after a time interval determined with respect to the timestamp of the unsuccessful attempt. In other embodiments, possibly complementary embodiments, where an obtaining comprises the determination of several timestamps, several relating to a same other future obtaining, one or more attempts may be able to be made, each at an instant corresponding to one of the different timestamps, until the establishment of a communication.

The time interval and/or the different timestamps relating to an establishment of a communication may notably be fixed according to information known to at least one of the terminals, notably:
to a degree of urgency assigned to a location of the first terminal by at least one of the terminals;
to a distance and/or a journey time between the departure and/or arrival points;
to a status of at least one of the terminals (notably a level of battery charge and/or an availability of a terminal);
to a cost of establishing a communication and/or in relation to a duration of communication;
to a level of quality of radio reception of a geographical area to which the departure and/or arrival point belong and/or in which one of the terminals has previously been located and/or near which the departure and/or arrival point is situated and/or one of the terminals has previously been located;
   to a log of communications between the two terminals.

According to the embodiments, the establishment of a communication can be initiated by one or other of the terminals. In the embodiment shown, the establishment 218 of the communication is initiated by the local terminal (102, 104). In other embodiments, it can be initiated by the remote terminal (102, 104), the establishment of the communication implementing, on the local terminal (102, 104) side, an acceptance of the communication initiated by the remote terminal (102, 104).

In the embodiment of FIG. 2, the communication is established 218 after the acquisition 216 of the location of the local terminal (102, 104). In other embodiments, in particular when the establishment of the communication 218 is carried out at the initiative of the remote terminal, the acquisition 216 of the geographical location of the local terminal can be carried out after the establishment 218 of the communication.

In the embodiment shown, the obtaining 210 further comprises at least one provision 220 of an item of information representative of the geographical location of one of the terminals (102, 104) to the other of said terminals. For example, in the embodiment shown, where each of the terminals is a mobile terminal, the local terminal (102, 104) communicates its geographical location to the remote terminal (102, 104) and receives the geographical location of the remote terminal (102, 104).

In other embodiments, for example an embodiment in which only one of the terminals is mobile or in which the arrival point of the mobile terminal whose route is obtained is a location known to the two terminals, only the mobile terminal whose route is obtained can communicate its geographical location.

In some embodiments, the provision 220 of the item of information representative of a location can consist in the provision, not of the location itself, but of an identifier (such as an access key in a common address book or a name (“Granny”, “Such-and-such shopping centre”, “Sophie's school”, etc.)) enabling the two terminals to identify the location.

In the embodiment shown, the obtaining then comprises a calculation 222 of at least one route, using the provided, acquired or determined locations.

This calculation 222 can in particular further comprise an estimation of a distance remaining to be travelled, of a journey time of the calculated route, etc.

The calculation is optional in some embodiments. Thus, the route can be calculated by one of the terminals and provided to the other terminal during the established communication. In such an embodiment, the method can comprise a reception, by the local terminal, of the route calculated by the remote terminal.

In the particular embodiment shown, the communication is established at the time of a first obtaining at the time of a predetermined timestamp, fixed for example in advance by one of the terminals at the time of the initialisation, for example by SMS exchange between the two terminals.

In other embodiments, implementing for example communication models of “publisher/subscriber” type, the timestamp of the first obtaining can be determined via subscriptions to events and exchanges of data messages between the terminals. Thus, in a particular embodiment, the method can comprise a prior declaration of an initial route of the first terminal, comprising a provision of one or more determined future obtaining timestamps. The second terminal can for example subscribe to be alerted of a prior route declaration by a terminal, notably the prior declaration of a route by the first terminal.

In another embodiment, the second terminal can propose a first obtaining timestamp to the first terminal and the first terminal be subscribed to the timestamp proposals relating to a first obtaining.

Such embodiments can for example enable a communication between terminals without requiring a mutual knowledge and therefore be suitable for applications (such as applications in the field of car sharing for example) involving a weak coupling between the terminals.

The determination of the first timestamp can also be carried out in a similar way to the timestamp determinations carried out at the time of subsequent obtainings, as discussed in more detail hereafter.

In fact, in some embodiments, the method can comprise obtainings subsequent to a first obtaining.

Thus, in the embodiment shown in FIG. 2, the method comprises several obtainings of routes. FIG. 1E shows different instants (140, 142, 144) of obtaining, relating to the obtaining of successive routes (110, 120, 130), shown by FIGS. 1B to 1D, of the mobile terminal (102,104).

In some embodiments, the obtaining 210 can comprise a determination of at least one parameter relating to at least one subsequent obtaining.

In some embodiments, the obtainings can be implemented periodically, using at least one determined timestamp relating to an establishment of a communication at the time of the first obtaining, the obtaining period being predetermined or fixed dynamically at the time of at least one of the obtainings Thus, the period can potentially be modifiable.

In the embodiment shown in FIGS. 1B to 1D, at the time of an obtaining 220 of a route 110, defined using the current locations of the two terminals, the two terminals determine some parameters relating to at least one other, subsequent obtaining of another route. The determination 224 of an obtaining parameter relating to a subsequent obtaining can notably comprise the determination of at least one timestamp relating to a future establishment of a communication, at the time of a subsequent obtaining. This may be in particular a timestamp relating to the next obtaining.

Such embodiments can enable for example at least one of the terminals to put itself into standby mode while awaiting the moment of the next route obtaining.

According to the embodiments, this may be a determination, for a subsequent obtaining, of one or more successive timestamp values, or of one or more time ranges. For example, in some embodiments implementing several communication attempts, the determined timestamp values, or timestamp range values, may be used successively for new attempts in the event of failure of the previous attempts.

The at least one timestamp to be determined for the establishment of a communication, at the time of a subsequent obtaining, can for example be imposed by one of the terminals, notably the mobile terminal, for example according to certain criteria (such as the level of charge of one of its batteries or its processing capacity already used for example, or an estimation of a future use of its processing capacity (by a video playing for example)). The timestamp to be determined for the establishment of a communication, at the time of a subsequent obtaining, can also be negotiated by the two terminals. Such an embodiment can notably comprise a proposal of at least one timestamp (or of items of information enabling the calculation of at least one timestamp, such as a duration to be added to a current timestamp) by one of the terminals and an acceptance of the proposal by the other terminal.

In some particular embodiments, in which each of the terminals proposes at least one timestamp, the determination of at least one timestamp relating to a subsequent obtaining can comprise a selection of at least one timestamp from among the proposed timestamps. For example, one of the selected timestamps can be the timestamp temporally closest to or furthest from one of the proposed timestamps, or an intermediate timestamp, or a timestamp close to a timestamp proposed by at least one of the two terminals or by the two terminals. A selected time range can be a time range proposed by one of the terminals, or a time portion common to a range proposed by a terminal and to a range proposed by the other terminal, such as the temporally closest and/or furthest common time range from among the range proposed by at least one of the two terminals, or an intermediate common range, or the temporally closest and/or furthest range from among the ranges proposed by at least one of the two terminals, or a time range including all of the proposed time ranges, etc.

In other embodiments, possibly complementary to the embodiments above, the timestamp can be determined by at least one or by each of the two terminals using predefined configuration data (for example a minimum and/or maximum duration and/or distance between two obtainings, a determined fixed, minimum and/or maximum number of obtainings, etc.) and/or other determined obtaining parameters and/or take account of the calculation 222 carried out at the time of the obtaining in progress. Thus, in the embodiment shown in FIG. 2, the determination of a timestamp relating to a communication to be established, at the time of the next obtaining, is carried out after the calculation 222 of the route and can take account of the calculation 222, notably of the estimation of the journey time of the route. For example, the timestamp relating to a communication to be established, at the time of the next obtaining, can be equal to the current timestamp, increased by the estimated journey time at the time of the route calculation and decreased by a predefined fixed duration (for example, a minute, five minutes, fifteen minutes) or by a duration determined, using a predefined ratio, with respect to the estimated journey time (for example 5%, 25%, 50%, 75%, 95%).

Thus, the determination 224 can comprise a reception, by the local terminal, of a proposal of at least one timestamp relating to a communication to be established, at the time of the next obtaining, or a transmission from the local terminal, to the remote terminal, of a proposal of at least one timestamp relating to a communication to be established, at the time of the next obtaining.

In some embodiments, the determination 224 can also comprise a transmission by the local terminal, of a confirmation, following a reception of a timestamp proposal or a reception, by the local terminal, of a confirmation, following a transmission of a proposal of a timestamp.

In the embodiment shown, the determination 224 can further comprise the determination of other obtaining parameters, provided by one of the terminals or negotiated by the two terminals, such as:
a type of wireless communication interface to be used for the establishment of the communication of at least one next obtaining;
a desired degree of precision of a geographical location provided at the time of at least one next obtaining;
a minimum and/or maximum duration of activation of a wireless communication interface at the time of a next obtaining;
an estimated time of autonomy of at least one battery of at least one of the terminals;
a level of charge of at least one battery of at least one of the terminals;
a current average speed of the mobile terminal;
a type of environment of at least one of the terminals (town, country or motorway, inside or outside).

In particular, the determination of the timestamp determined for the establishment of a communication, at the time of the next obtaining can be carried out after the determination of certain other obtaining parameters and can take account of at least some of these obtaining parameters (for example of the estimated time of autonomy of the batteries of the two terminals).

In some embodiments, in which the calculation 222 of the route is carried out at least partially before the determination, the determination 224 can also take account of variables calculated at the time of the calculation 222 of the route such as an estimated length of the route, or a proximity of said departure and/or arrival point to a predefined location area (such as an area of non-coverage by the selected wireless communication means, also called “dead zones”), in which the establishment of wireless communication can be difficult or even impossible.

When the determination 224 and the calculation 222 are carried out in parallel, the determination of certain obtaining parameters can take account of variables whose calculation itself takes account of other obtaining parameters. For example, the timestamp determined for the establishment of a communication, at the time of the next obtaining, can take account of an estimated journey time of the route before reaching a particular location (such as an arrival point, or a predefined area such as a dead zone, or a particular intermediate point obtained from the user), itself calculated by taking account of an obtaining parameter such as the current average speed of the mobile terminal.

In the embodiment shown, the determination 224 of a timestamp of a next obtaining can notably take account of a quality of radio coverage near an estimated geographical position of one of the terminals, at the time of a timestamp proposed or selected for a next obtaining (for example using radio quality maps loaded into the memory of one at least of the two terminals, associating a radio quality with a geographical location).

Thus, when several obtaining timestamps are proposed, the determination can for example comprise a selection from among the proposed timestamps of that associated with the best radio coverage for the two terminals.

Such embodiments can for example make it possible to reduce the number of attempts necessary to establish a communication of a future obtaining, predictively.

In the embodiment shown in FIG. 2, the obtaining 210 further comprises a termination 226 of the established communication, then a deactivation 228 of the wireless communication interface used for the establishment 218 of the communication. A deactivation 228 can for example make it possible to reduce the energy consumption of the local terminal between two obtainings According to the embodiments, the deactivation 228 can be carried out systematically after the determination 224, or conditionally, for example according to the level of charge of the battery of the local terminal or an estimated journey distance at the time of the calculation 222 of the route of the mobile terminal or when the next obtaining implements a wireless communication interface different from that currently activated.

The method can also comprise a restitution 230 of at least one of the routes obtained on the local terminal, for example on a graphic screen.

According to the embodiments, this may be a restitution 230 of the routes obtained successively by the local terminal, or of certain routes obtained (for example the latest).

In some embodiments, the selection 212 of the type of wireless communication interface to be used for the establishment 218 of a communication, at the time of an obtaining, can notably be a function of at least one obtaining parameter determined at the time of a previous obtaining (for example a type of interface received from the remote terminal), or of the route calculation 222 carried out at the time of a previous obtaining, for example of an approximate journey time by the local and/or remote terminal of a previously obtained route. In fact, some types of wireless communication consume less energy than others but provide a lower location precision. Moreover, some types of wireless communication, such as Wifi® for example, are more suitable for an urban environment that a use in the country.

Thus, in the embodiment shown in FIG. 2, in which several obtainings are implemented, and where the two terminals possess wireless interfaces of 3G, GSM and Wifi type, the selection carried out at the time of the first obtaining will result in a choice of a communication interface of 3G type, a subsequent selection resulting for example in the choice of an interface of Wifi® type in an urban environment. In another embodiment, an obtaining can be carried out by wifi, in a wifi coverage area, and a subsequent obtaining use 3G, in an area without Wifi coverage.

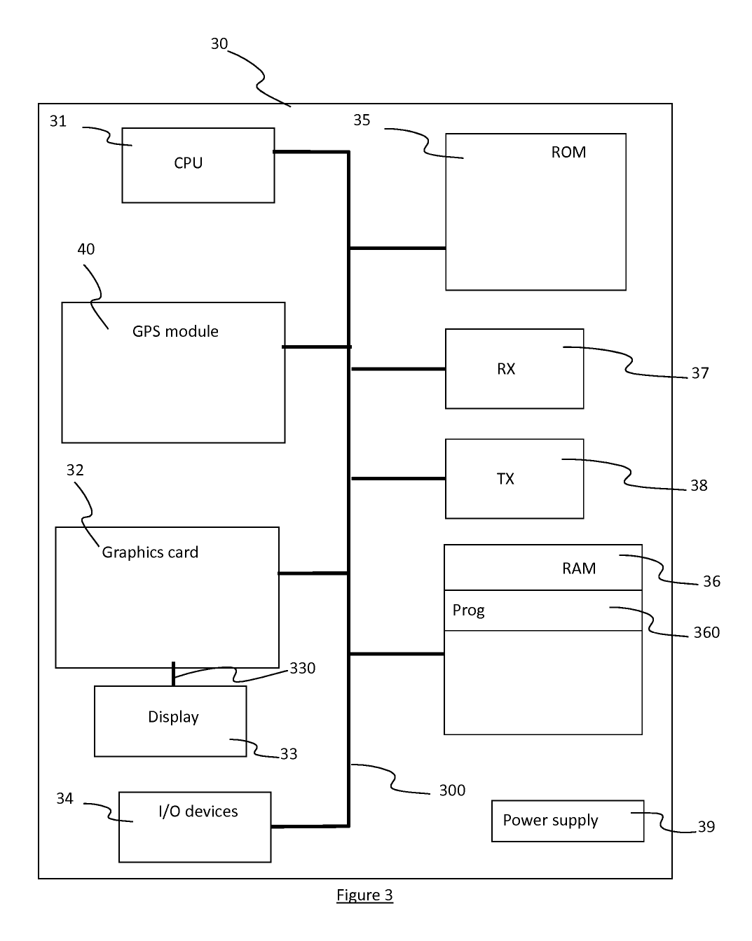

A terminal suitable for the implementation of the invention, in at least one of its embodiments, is now presented in FIG. 3 in more detail. According to the embodiments of the invention, this may or may not be a mobile terminal FIG. 3 diagrammatically shows a hardware embodiment of a terminal 30, possibly corresponding to the terminal 102 or to the terminal 104 of FIG. 4, suitable for the implementation of the location method of the invention, in one of its embodiments.

The terminal 30 corresponds for example to a laptop, a tablet or a smartphone. It may also be another electronic device, notably a portable electronic device, such as a connected watch for example, or a terminal embedded in a vehicle (such as a car, a truck, a boat, a train, etc.), for example a terminal comprised in the dashboard of the vehicle (also called “in vehicle infotainment”).

In the particular embodiment shown, the terminal 30 comprises the following modules, connected to each other by an address and data bus 300 which also transports a clock signal:
a microprocessor 31 (or CPU);
a graphics card 32 (optional in some embodiments, notably in embodiments in which no route restitution is carried out on the terminal 30);
one or more I/O (Input/Output) devices 34 such as for example a keyboard, a mouse, a webcam, a microphone, a loudspeaker, etc.;
a non-volatile memory of ROM (read only memory) type 35;
a random access memory (RAM) 36;
at least one RX communication interface 37 configured for the reception of data, for example via a wireless (notably Wifi®, Bluetooth or GSM type) connection;
at least one communication interface 38 configured for the transmission of data, for example via a wireless (notably Wifi®, Bluetooth or GSM type) connection;
a power supply 39.

In the embodiment of FIG. 3, the terminal further comprises a geographical location module 40, for example a module of GPS (Global Positioning System) type.

FIG. 3 shows a simplified representation of a terminal and the bus 300, according to some embodiments, can be in particular a logical and non-physical bus. For example, the terminal 30 can use a remote GPS location module, implemented on a smartphone with which the terminal 30 communicates by means of wired (USB cable for example) or wireless (Bluetooth, Wifi, etc.) communication.

In some embodiments, the terminal 30 may also comprise or be connected to a display device 33 of display screen type directly connected to the graphics card 32 by a dedicated bus 330. According to a variant, a device for displaying is external to the terminal 30. In some embodiments, the terminal 30 can be connected to the display device 33 by wireless communication modules. In other embodiments, the terminal can be connected to the display device 33 by a cable transmitting the display signals. The terminal 30, for example in the graphics card 32, comprises a transmission module or connector (not shown in FIG. 3) adapted to transmit a display signal to an external display module such as for example an LCD or plasma screen or a video projector.

Each of the memories mentioned can comprise at least one “register”, that is to say a memory zone of low capacity (some binary data) or a memory zone of large capacity (making it possible to store a whole programme or all or part of the data representative of data calculated or to be displayed).

When switched on, the microprocessor 31 loads and executes the instructions of the program contained in a register 360 of the RAM 36, and notably the algorithms implementing the steps of the method specific to the invention and described below.

According to a variant, the terminal 30 comprises several microprocessors.

According to another variant, the power supply 39 is external to the terminal 30.

In an embodiment, compatible with the embodiment shown in FIG. 3, the microprocessor 31 can in particular be configured for:
at least one obtaining of at least one route of said mobile terminal, defined by at least:
   a departure point, representative of a geographical location of said mobile terminal;
   an arrival point, representative of a determined geographical location.

In the particular embodiment shown, the processor is further configured so that said obtaining comprises at least:
an establishment of a communication between the mobile terminal and another terminal, at an instant which is a function of a determined timestamp;
a provision of said geographical location of said mobile terminal and/or a geographical location of said other terminal during said communication.

In another embodiment, also compatible with the embodiment shown in FIG. 3, the microprocessor 31 can in particular be configured for:
at least one obtaining of at least one route of another terminal, said other terminal being mobile, said route being defined by at least:
   a departure point, representative of a geographical location of said other terminal;
   an arrival point, representative of a determined geographical location.

In the particular embodiment shown, the processor is further configured so that said obtaining comprises at least:
an establishment of a communication between the terminal and said other terminal, at an instant which is a function of a determined timestamp;
a provision of said geographical location of said other terminal and/or a geographical location of said terminal during said communication.

The terminal of FIG. 3 can notably be built into a vehicle, for example into its dashboard. Such a vehicle can in particular comprise, as well as locomotion and control modules, access points to a wireless communication network.

1-10. (canceled)

11. A method for locating at least one first mobile terminal, said method comprising:
at least one first and one second obtaining of at least one route of said first mobile terminal, said route being defined by at least:
a departure point, representative of a first geographical location of said first mobile terminal;
an arrival point, representative of a second geographical location;
said first and said second obtaining comprising at least:
an establishment of a communication between said first terminal and a second terminal, at an instant which is a function of at least one timestamp;
a provision of said first geographical location of said first terminal and/or a geographical location of said second terminal during said communication;
wherein, during the communication established at a time of said first obtaining, said first obtaining comprises determining at least one obtaining parameter relating to said second obtaining, a first of said at least one obtaining parameter being a timestamp relating to the establishment of the communication of said second obtaining.

12. The method according to claim 11, said method being implemented in the first terminal and/or in the second terminal.

13. The method according to claim 11, wherein said at least one obtaining parameter relating to said second obtaining comprises at least one second parameter belonging to the group comprising:
a type of wireless communication interface to be used for the establishment of the communication of said second obtaining;
a desired degree of precision of said geographical location provided at the time of said second obtaining;
a minimum duration of activation of a wireless communication interface during said second obtaining;
a maximum duration of activation of a wireless communication interface during said second obtaining;
an estimated time of autonomy of at least one battery of said first and/or second terminal;
a level of charge of at least one battery of said first and/or second terminal;
a current average speed of said first and/or second terminal;
a type of environment of said first and/or second terminal.

14. The method according to claim 11, wherein said obtaining comprises deactivating at least one wireless communication interface carried out at the time of said communication.

15. The method according to claim 11, wherein, during the communication established at the time of said first obtaining, said first obtaining comprises a proposal, by one of said terminals to the other of said terminals, of at least one timestamp relating to an establishment of the communication of said second obtaining.

16. The method according to claim 11, wherein the timestamp of the establishment of the communication of said second obtaining takes account of at least one item of information belonging to the group comprising:
a degree of urgency assigned to a location of said first terminal by at least one of said terminals;
a distance and/or a journey time between said departure and/or arrival points;
a status of at least one of said terminals;
a cost of establishment of a communication;
a duration of communication;
a level of quality of radio reception of at least one geographical area;
a log of communications between the two terminals.

17. A mobile communication terminal comprising a geographical location module and at least one processor configured for:
at least one first and one second obtaining of at least one route of said mobile terminal, said route being defined by at least:
a departure point, representative of a first geographical location of said mobile terminal;
an arrival point, representative of a second geographical location;
said first and said second obtaining comprising at least:
an establishment of a communication between the mobile terminal and another terminal, at an instant which is a function of at least one timestamp;
a provision of said first geographical location of said mobile terminal and/or a geographical location of said other terminal during said communication
wherein said first obtaining comprises, during the communication established at a time of said first obtaining, determining at least one obtaining parameter relating to said second obtaining, a first of said at least one obtaining parameters being the timestamp of the establishment of the communication of said second obtaining.

18. The mobile communication terminal according to claim 17, wherein said arrival point takes account of a geographical location of said another terminal.

19. The mobile communication terminal according to claim 17, wherein said second geographical location is a location other than a geographical location of said another terminal.

20. The mobile communication terminal according to claim 17, wherein the timestamp of the establishment of the communication of said second obtaining takes into account a level of charge of at least one battery of said mobile communication terminal and/or a level of charge of at least one battery of said another terminal.

21. The mobile communication terminal according to claim 17, wherein the timestamp of the establishment of the communication of said second obtaining takes into account an availability of a processing capacity of said mobile communication terminal and/or an availability of a processing capacity of said another terminal.

22. A communication terminal comprising a processor configured for:
at least one first and one second obtaining of at least one route of another terminal, said other terminal being mobile, said route being defined by at least:
a departure point, representative of a first geographical location of said other terminal;
an arrival point, representative of a second geographical location;
said first and said second obtaining comprising at least:
an establishment of a communication between the terminal and said other terminal, at an instant which is a function of at least one timestamp;
a provision of said first geographical location of said other terminal and/or a geographical location of said terminal during said communication.
wherein said processor is configured so that said first obtaining comprises, during the communication established at a time of said first obtaining, determining at least one obtaining parameter relating to said second obtaining, a first of said at least one obtaining parameters being the timestamp of the establishment of the communication of said second obtaining.

23. The communication terminal according to claim 22, wherein said arrival point takes account of a geographical location of said communication terminal.

24. The communication terminal according to claim 22, wherein said second geographical location is a location other than a geographical location of said communication terminal.

25. The communication terminal according to claim 22, wherein the timestamp of the establishment of the communication of said second obtaining takes into account an availability of a processing capacity of said communication terminal and/or an availability of a processing capacity of said another terminal.

26. A vehicle equipped with the mobile communication terminal of claim 17.

27. A Vehicle equipped with the communication terminal of claim 22.

28. A computer program product, comprising program code instructions for executing the method according to claim 11, when said program is executed by a computer.

29. A computer-readable storage medium on which is saved a computer program comprising program code instructions for executing the method according to claim 11, when said program is executed by a computer.
